(19) United States
(12) Patent Application Publication
(10) Pub. No.: US 2022/0114850 A1
(43) Pub. Date: Apr. 14, 2022

(54) Programmable Lock Food Delivery Container

(71) Applicants: Jacqueline Foster, Sacramento, CA (US); Riley August, Mississauga (CA); Matteo Borri, San Rafael, CA (US)

(72) Inventors: Jacqueline Foster, Sacramento, CA (US); Riley August, Mississauga (CA); Matteo Borri, San Rafael, CA (US)

(73) Assignee: Jacqueline Foster, Sacramento, CA (US)

(21) Appl. No.: 17/170,410

(22) Filed: Feb. 8, 2021

Related U.S. Application Data
(63) Continuation-in-part of application No. PCT/US21/14803, filed on Jan. 23, 2021.
Application No. PCT/US21/14803 is a continuation-in-part of application No. 17/067,545, filed on Oct. 9, 2020.

(51) Int. Cl. G07C 9/00

(52) U.S. Cl. CPC G07C 9/00817; G07C 9/00309; G07C 2009/00801; G07C 2009/00825; G07C 2009/00841; G07C 9/00912

(57) ABSTRACT

A programmable locking assembly for an insulated food grade container, such as a food delivery container, that can be unlocked by the recipient of the container by pressing a number code on the keypad of the lock, causing a locking finger to slide out from a zipper pull on the lid of the insulated food grade container to allow the recipient to unzip the lid to gain access to the contents of the container, thereby preventing the food delivery person to access the contents of the container while in route to making the delivery. In an alternate embodiment, an audio tone can open the lock without the user needing to press numbers on the keypad. The number code and/or the audio tone are texted to the recipient's cellular phone from the sender of the container.

### CROSS REFERENCE TO RELATED APPLICATIONS

This application is a continuation-in-part of International Application Serial No.: PCT/US21/14803, filed on Jan. 23, 2021, which is a continuation-in-part of patent application U.S. patent application Ser. No. 17/067,545 filed Oct. 9, 2020, which claims priority to Provisional Patent Application, 62/964,836, filed Jan. 23, 2020, the entire specifications of which are incorporated herein by reference.

### STATEMENT REGARDING FEDERALLY SPONSORED RESEARCH OR DEVELOPMENT

Not Applicable.

### DESCRIPTION OF ATTACHED APPENDIX

Not Applicable.

### BACKGROUND OF THE INVENTION

This invention relates generally to the field of lockable containers and more specifically, however not exclusively, to a food grade programmable lock insulated food grade container and insulated food storage bag, primarily, for use for food delivery services.

Food delivery from restaurants to customers in their homes or offices has become very popular.

Basically, the restaurant puts the food in an insulated food grade container and has a food delivery person transport the container to the recipient, at which time the recipient removes the food from the container and takes it into their home or office.

However, there have been reported cases of food delivery people gaining access to the insulated food grade container and partaking of the food inside before making the delivery to the end customer. This situation is unacceptable both for the reason of the theft of food and for the possibility of having the food become contaminated by the delivery person's fingers.

This invention furthermore relates to any field requiring secure programmable lock transportation, such as documents, financial instruments, or medical substances.

### BRIEF SUMMARY OF THE INSTANT INVENTION

The primary object of the invention is to provide a lockable container whose lock can be programmed with a custom number sequence which an end user needs to know in order to open the container. References to “container” in the instant application should be understood to mean in some embodiments a bag, in some embodiments a box and in some embodiments any type of enclosure.

Another object of the invention is to provide a programmable lock container that is food grade insulated, used for food and drink delivery from restaurants to individuals at their homes or offices thereby preventing the delivery person from having access to the contents of the container. The container comprises reconfigurable compartments of various sizes, and furthermore the container can be constructed as a box or preferably constructed as a collapsible food delivery bag.

Another object of the invention is to provide a programmable lock container that allows a restaurant to send a numerical text to the recipient of the boxed food to so that the recipient can enter the numerical code to open the container.

A further object of the invention is to provide a programmable lock container that allows the recipient of the boxed food to place their smart phone near the container hand have the phone send an audio signal that will unlock the container so that the recipient does not have to physically touch the keypad of the lock.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a programmable lock container comprising: an insulated food grade container, an lock assembly, a number code receiver assembly enclosed within a housing, a number code receiver holster, an electronic numerical code generating system, a phone texting electronic system that sends the electronic numerical code to the smart phone of the recipient of the insulated food grade container, the lock assembly including an electro-mechanical sliding u-shaped finger locking member that extends through an aperture in the insulated food grade container, the number code receiver holster fixedly attached to the outside wall of the insulated food grade container, the u-shaped finger locking member also capable of penetrating an aperture in a metal flange attached to the holster and also penetrating an aperture in a zipper pull tab, the number code receiver assembly including a keypad, a numeric display, a programmable microprocessor, a rechargeable battery and a short range receiver contained within a hollow housing, the recipient of the insulated food grade container capable of sliding the u-shaped locking finger away from the aperture of the zipper pull tab by pressing the proper code numbers received from the phone texting electronic system thereby allowing the recipient to unzip the lid of the container and have access to the contents of the container.

### BRIEF DESCRIPTION OF THE DRAWINGS

The drawings constitute a part of this specification and include exemplary embodiments to the instant invention, which may be embodied in various forms. It is to be understood that in some instances various aspects of the instant embodiments may be shown exaggerated or enlarged to facilitate an understanding of the instant embodiment.

FIG. 1 is a perspective view of a programmable locking assembly for a delivery container according to some embodiments.

FIG. 2 is a partial perspective view of the assembly shown in FIG. 1.

FIG. 3 is a partial perspective view of the assembly with the code number receiving housing removed from its retaining holster according to some embodiments.

FIG. 4 is a partial perspective view of the embodiment showing the U-shaped locking finger in the locked position according to some embodiments.

FIG. 5 is a partial perspective view of the embodiment showing the U-shaped locking finger in the unlocked position according to some embodiments.

FIG. 6 is perspective view of the housing for the electro-mechanical locking assembly according to some embodiments.

FIG. 7 is an exploded view with the rear of the electro-mechanical housing removed according to some embodiments.

FIG. 8 is a front view of the interior of the electro-mechanical locking assembly according to some embodiments.

FIG. 9 is a front view of the interior of the electro-mechanical locking assembly in the unlocked position according to some embodiments.

FIG. 10 is a perspective view of the interior of the code number receiving housing according to some embodiments.

FIG. 11 is a perspective view of the electro-mechanical locking assembly removed from the code number housing.

FIG. 12 is a perspective view of the electro-mechanical locking assembly about to be installed within the container according to some embodiments.

FIG. 13 is a partial perspective view of the electro-mechanical locking assembly attached to the inside of the container according to some embodiments.

FIG. 14 is a perspective view of a code number receiving housing about to be inserted into a charging station according to some embodiments.

FIG. 15 is a perspective view of six code number receiving housings being recharged in a charging station according to some embodiments.

FIG. 16 is a front view of the bag according to some embodiments.

FIG. 17 is top view of three sizes of the bag according to some embodiments.

FIG. 18 is a top view of the large bag embodiment with the lid removed.

FIG. 19 is a top view of the small bag embodiment with the lid removed.

FIG. 20 is a schematic diagram illustrating operation of electronic devices to control the programmable lock of the delivery container.

FIG. 21 is a block diagram illustrating the operation of the system to control the programmable lock of the delivery container.

FIG. 22 is an exemplary computer device for practicing aspects of the present technology.

FIG. 23A is a method of operating the system of FIG. 21,

FIG. 23B is the method of operating the system continued from FIG. 23A.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

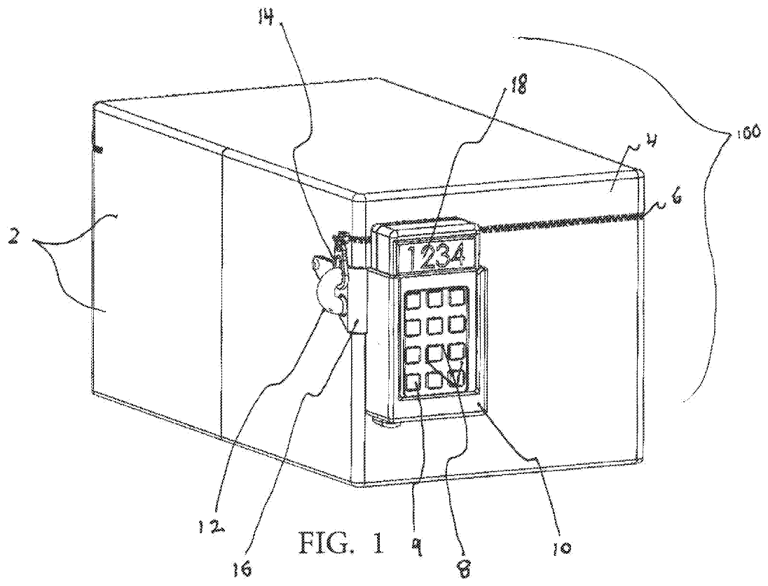

Referring now to FIG. 1 we see a perspective view of the embodiment 100 An insulated food grade container 2 includes a zippered 6 lid 4. The zipper pull 14 is restricted from being pulled by U-shaped finger locking member locking member 12. A number code receiving device 8 is installed in a holster 10. The rigid holster 10 includes a rigid flange 16 that reinforces the apertures that retain the U-shaped finger locking member 12. Therefore, the container 2 can be made of sewn material such as ballistic nylon and yet the flange area 16 of the U-shaped finger locking member 12 hardens the connection point between the U-shaped finger locking member 12 and the container 2. In the instance of food delivery, a person at the restaurant sending the food uses a custom electronic software program to program a unique sequence of numbers in a microprocessor located within the number code receiving device 8 housing. A delivery person then transports the container 2 to a recipient at a home or office. The restaurant person texts a unique sequence of numbers to the recipient's smart phone. The recipient can then press the keypad numbers 9 in the sequence shown in the text message to cause the U-shaped finger locking member lock to slide out, thereby gaining access to the zipper pull 14. In this way, only the recipient, and not the food delivery person, has access to the food being stored within the container 2.

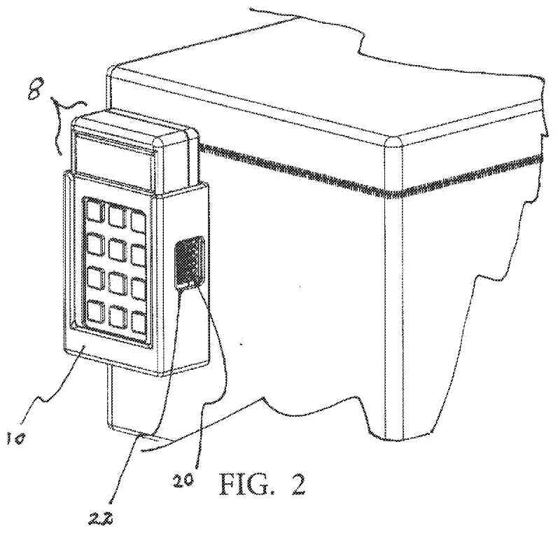

FIG. 2 shows the right side of the holster 10 where an aperture 22 in the holster 10 allows the reception of an audible tone to enter grill 20 or code receiving unit 8. The audible tone is an optional way to cause the lock to open as will be discussed below. The code receiving device 8 includes a keypad 9 and a numerical display 18. The upper portion of the number code receiving device 18 confirms the numbers that the recipient has selected. Another way that the recipient can activate the lock is to place his or her smart phone near the container and to press an audio option within the text message which then generates tones associated with each number. A microphone 42 within the number code receiving housing hears the tones and unlocks the U-shaped finger locking member 12 when the correct sequence of tones is heard.

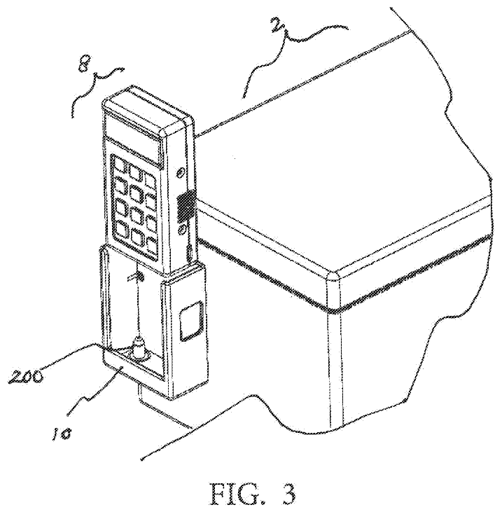

FIG. 3 shows the code receiving unit 8 being removed from the holster 10. An electrical connection point 200 an be seen which interacts with a mating connector 38 on the underside of the code receiving unit 8. This connection provides the electrical conduit for sending a signal from the code receiving unit 8 to an electro-mechanical assembly 26 located within the container 2 that causes the U-shaped finger locking member 12 to slide in or out to lock or unlock the zipper pull of the lid of the container 2.

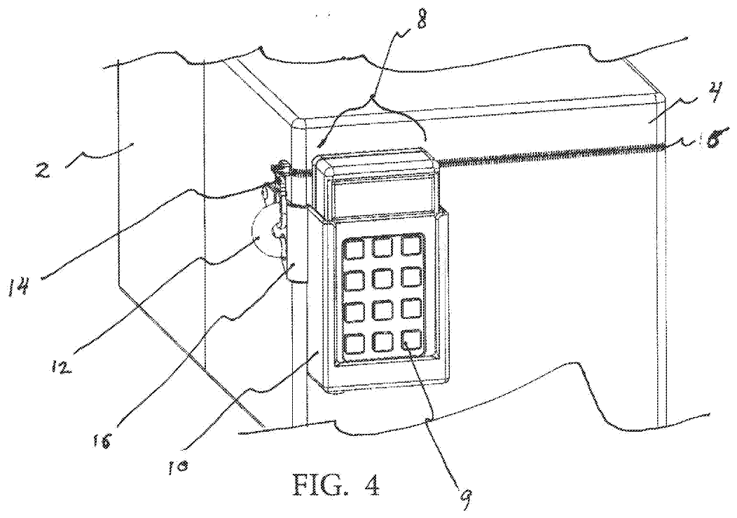

FIG. 4 shows the number code receiving device sitting in holster 10 with the U-shaped finger locking member 12 in the locked position.

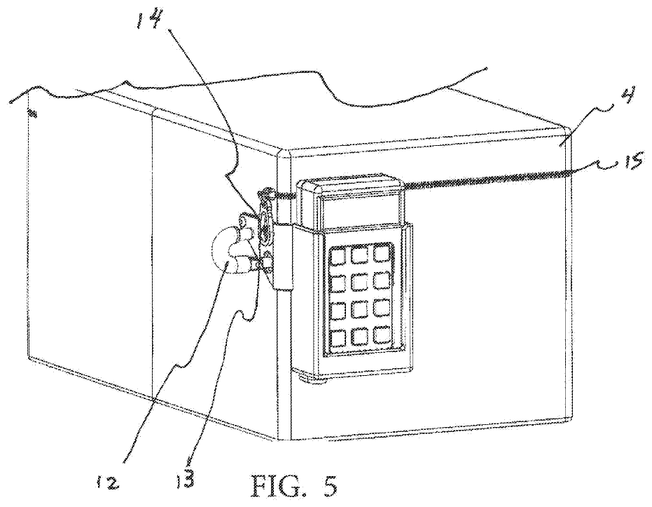

FIG. 5 shows the U-shaped finger locking member in the unlocked position, allowing free access to zipper pull 14 because the U-shaped finger locking member 12 has exited zipper pull aperture 13.

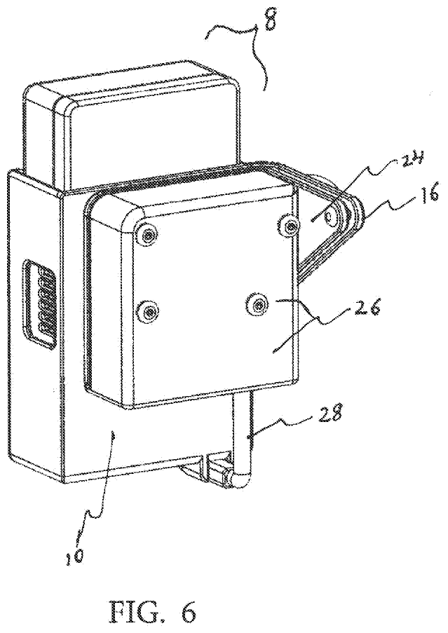

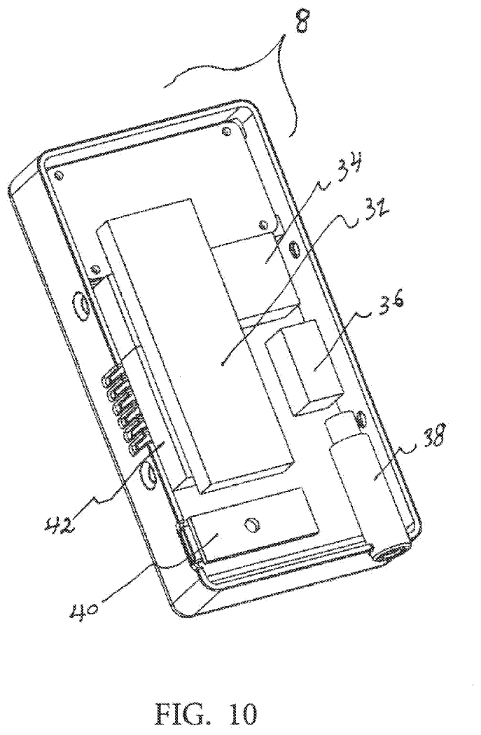

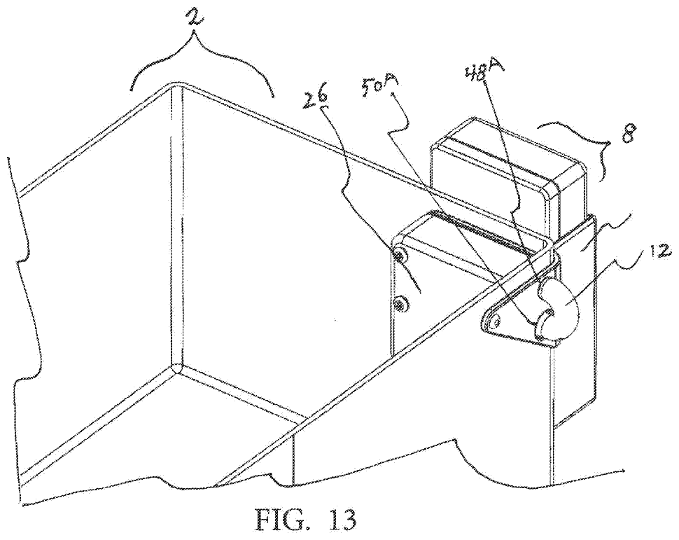

FIG. 6 shows the housing 26 of the electro-mechanical lock assembly. The housing 26 includes a flange 24 that is parallel to, and in close proximity, to holster flange 16. The side wall of the container 2 is trapped between the rear wall of holster 10 and the front wall of housing 26 as shown in FIG. 13. Cable 28 acts as a conduit between the microprocessor 34 within the code receiving housing 8 as shown in FIG. 10.

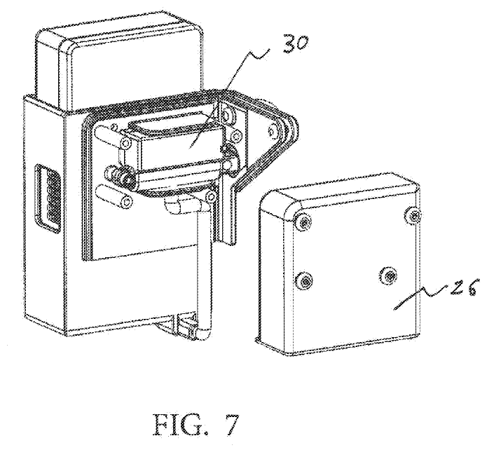

FIG. 7 shows the housing cover 26 removed exposing electro-mechanical linear translation device 30.

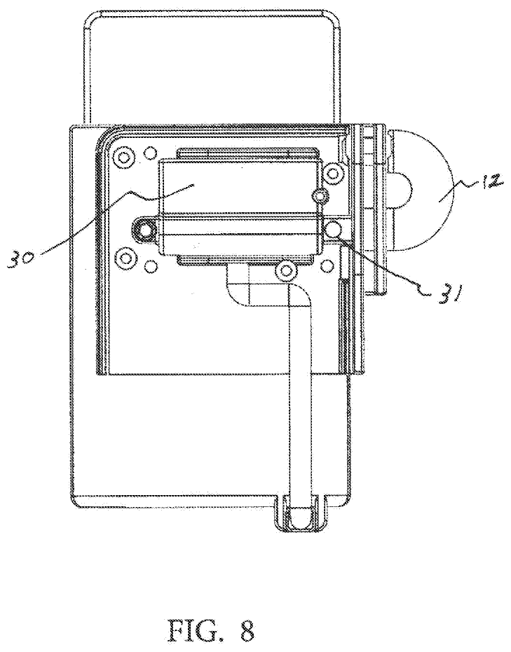

FIG. 8 shows a front view of the linear translation device 30 whose shaft 31 is fixedly attached to U-shaped finger locking member 12.

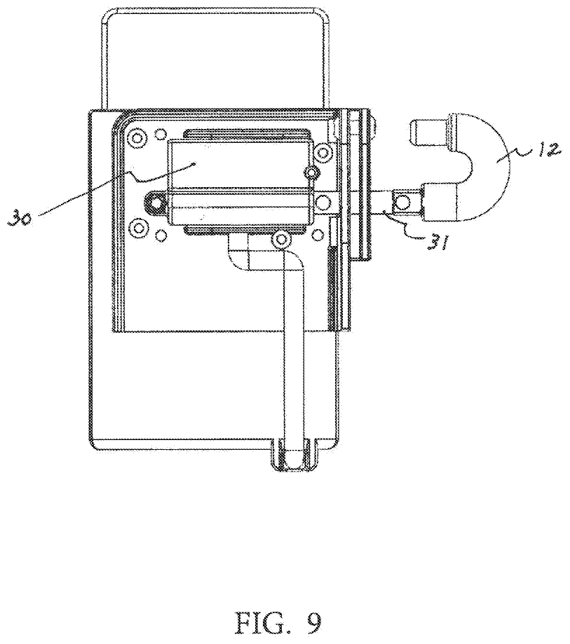

FIG. 9 shows U-shaped finger locking member 12 in the open position as shaft 31 has forced it open.

FIG. 10 shows the number code receiving housing 8 with the rear panel removed exposing rechargeable battery 32, microprocessor 34, microphone 42, battery charging port 40, cable receptacle 38 and short-range receiver 36.

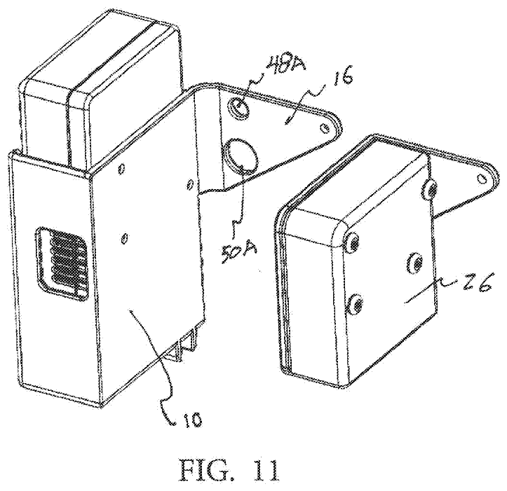

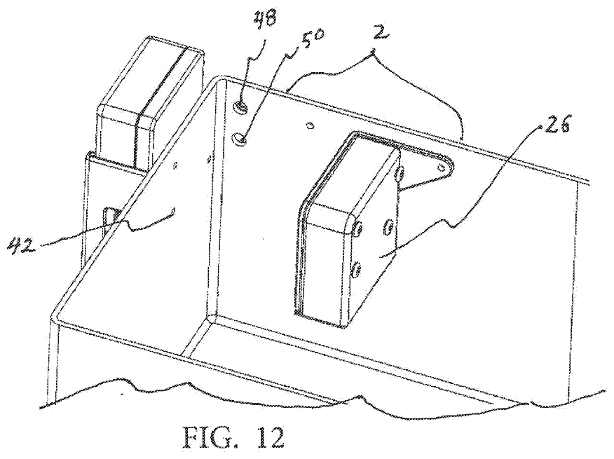

FIGS. 11 and 12 shows the electro-mechanical assembly 26 about to be attached to the rear of holster 10 via screws that enter apertures 42. Note that apertures 48, 50 are shown in the side wall of container 2 which correspond to the apertures 48A and 50A shown flange 16 in FIG. 11.

FIG. 13 shows the electro-mechanical housing 26 in place on the inside wall of container 2 and U-shaped finger locking member 12 in the locked position as it penetrates apertures 48A and 50A.

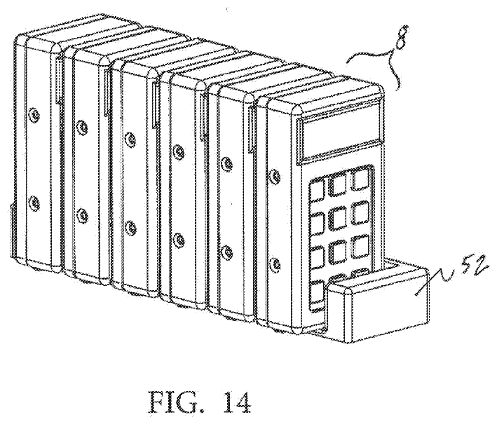

FIG. 14 shows a plurality of number code receiving devices 8 installed within charger base 52.

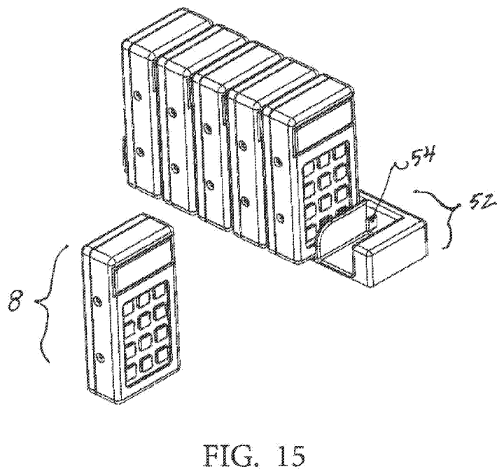

FIG. 15 shows one number code receiving device 8 removed exposing the connection point 54 between the receiving device 8 and the charging circuit located within the charging station housing 52. This connection 54 also acts as a conduit for sending a unique numerical code to the number code receiving device 8. Each time the receiving device 8 is inserted into the charger base 52, a new code is generated. The new code is then sent to the recipient of the container 2.

It should be noted that the above described lockable container can be used for purposes other than food delivery where an item needs to be delivered and the person sending the item wants to make sure that the person doing the delivering cannot gain access to the item, and that only the authorized recipient can gain access to the contents of the container.

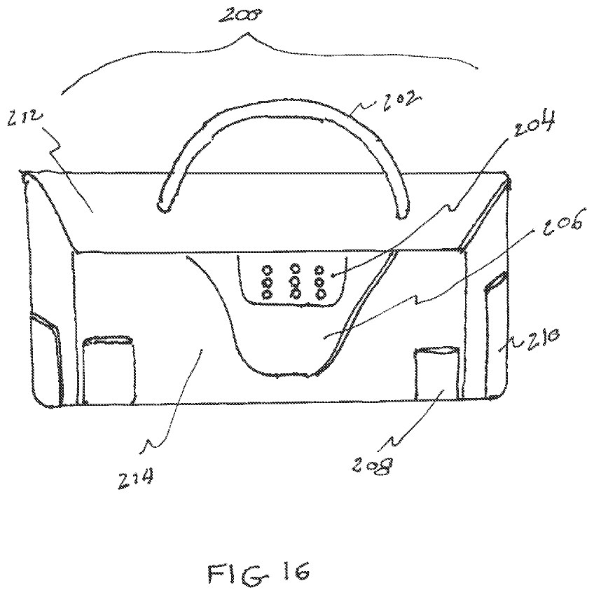

FIG. 16 is a second embodiment of the embodiment 200. This embodiment is in the form of a bag made up of a food holding portion 214 and a fold over flap 212 that includes a keypad 204 for locking and unlocking the bag 200 and an additional flap 206. Pockets 208, 210 on each side of the bag 200 can hold additional items. A handle 202 allows a user to carry the bag 200.

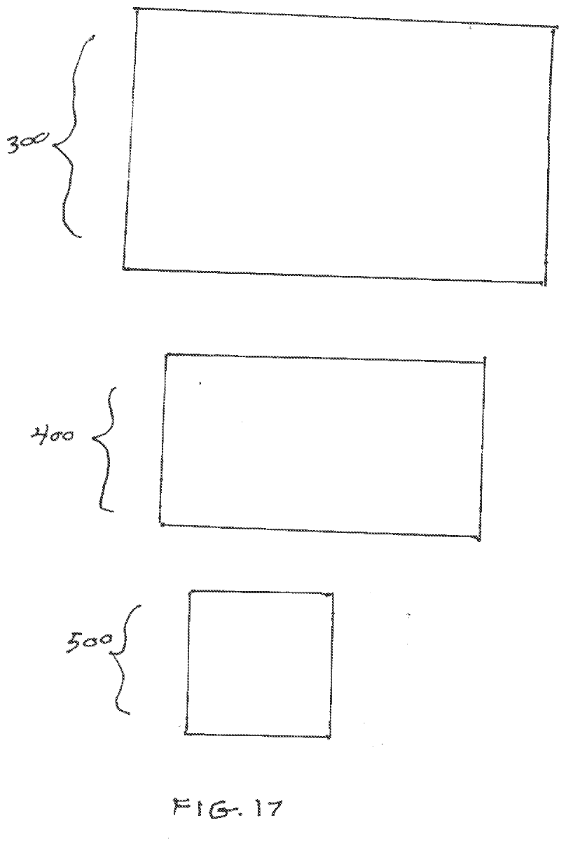

FIG. 17 is a top plan view of three bags. Bag 300 is eighteen inches by twenty-two inches. Bag 400 is ten inches by fifteen inches and bag 500 is ten inches by ten inches. The present embodiment 100 can be made in a variety of sizes as described above.

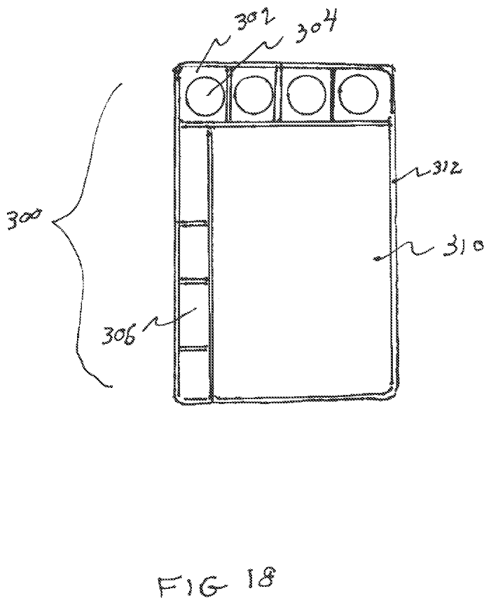

FIG. 18 is a top view of the large bag 300 with the lid removed showing an interior that includes a major area for food storage 310 and smaller areas 302 for drink 304 storage and condiment storage 306. All bags are insulated with a layer of food grade insulation 312.

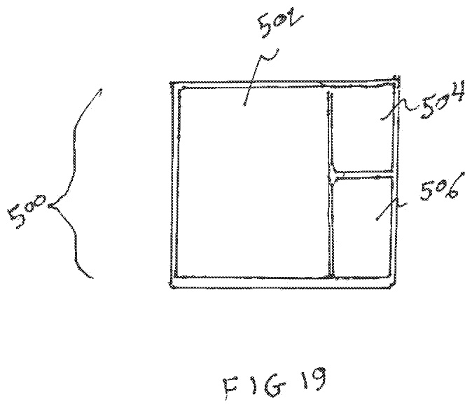

FIG. 19 is a top view of the small bag 500 with the top lid removed showing a main food compartment 502, and two smaller food compartments 504, 506.

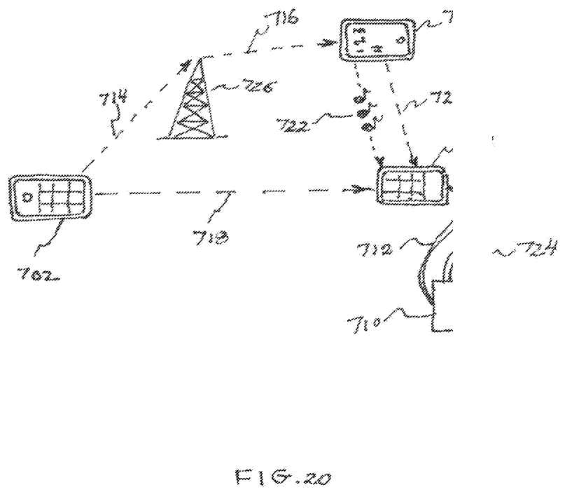

FIG. 20 is a schematic view of the embodiment. A first cell phone 702 is programed to enable a restaurant person to enter a unique numerical code into a cell phone 708 which is located on the side of the delivery container via Bluetooth wireless connection 718. The recipient of the delivery container is then sent a text message 714, 716 via cell phone wireless connection 726 to his or her cell phone 706 which displays a numerical code and an optional audible code. The recipient of the delivery container then either types in the numerical code into the keypad graphic on the cell phone 708 mounted on the side of the delivery container or presses a button on his or her cell phone 706 to initiate a series of audible tones 722 that the delivery container cell phone 708 can understand. Either the typed in code numbers or the audible tones cause the linear actuator 710 to unlock the locking mechanism 724 which is connected to cell phone 708 by an electrical cable 712.

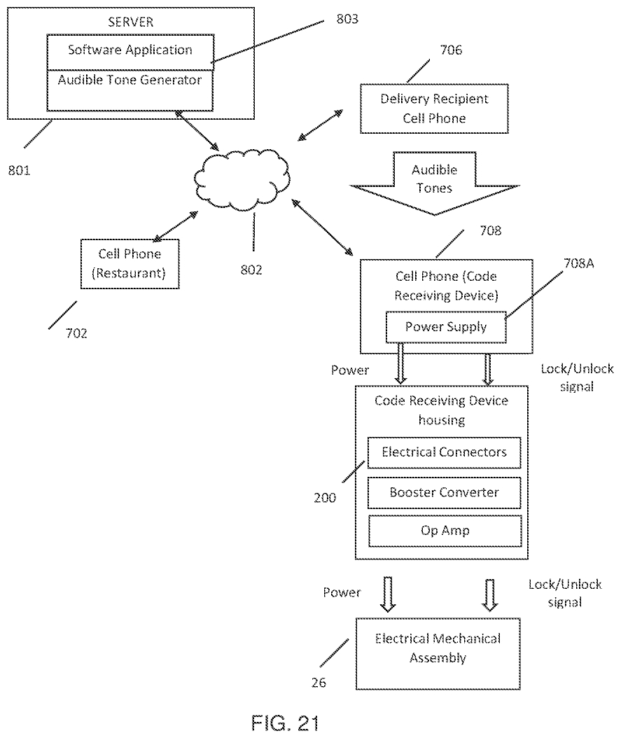

FIG. 21 is a block diagram illustrating the system to control the programmable lock assembly for the delivery container according to some embodiments. The first cell phone 702, server 801, recipient's cell phone 706 and code receiving device 8 (which in some embodiments may be a cellular phone 708) are operably connected to one or more networks 802. In some embodiments, the electro-mechanical assembly 26 can be the electro-mechanical assembly/locking mechanism of any one of the programmable lock assemblies of the embodiments disclosed herein. In some embodiments, the electro-mechanical assembly 26 of the programmable lock can be used on any one of the delivery containers of the embodiments disclosed herein. Electro-mechanical assembly 26 includes a booster converter and operational amplifier configured to run in comparator mode (for comparing code signals etc.). The lock/unlock signal in some embodiments is a pulse width modulated signal or a serial signal. In some embodiments, the electro-mechanical assembly includes a standard servo. In some other embodiments, a linear servo is used. As mentioned hereinbefore with reference to the FIG. 3, the code receiving unit 8 in some embodiments is a cellular phone which has a power supply/battery 708A. Power supply/battery 708A is electrical attached to electro-mechanical assembly 26 (as explained herein before with reference to FIG. 3). A software application 803 runs on server 801 and/or cellular phones 702 and 708.

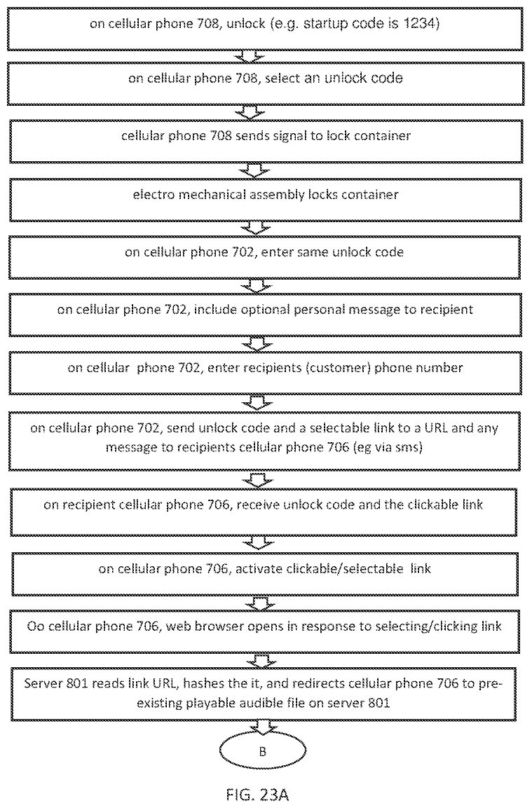

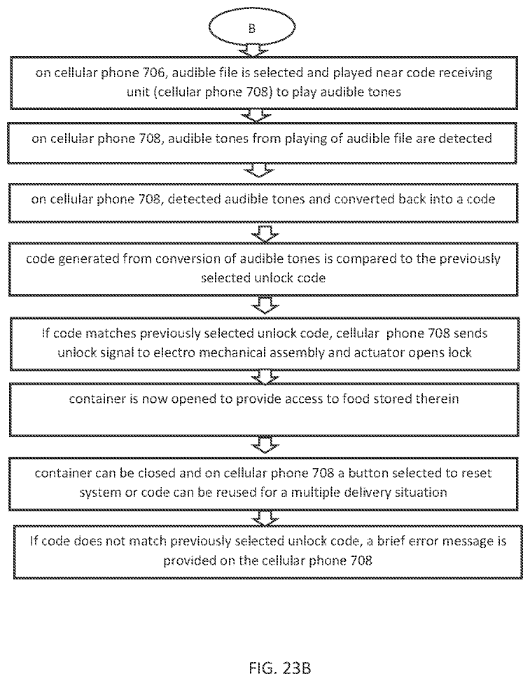

A method of operation of the system of FIG. 21 will now be described with reference to FIGS. 23A and 23B according to some embodiments. Initially, on cellular phone 708, the phone is unlocked (for example by using a startup code “1234”) by a user, such as for example a person in a restaurant managing a to go order meal from a customer. Once the food is ready and placed in the container, on a code receiving unit 8 (cellular phone 708 in this example), an unlock code is selected. In response, cellular phone 708 sends a signal to lock container. In response, electro-mechanical assembly locks the container with the food inside. On cellular phone 702, the same unlock code is entered together with any message for a recipient. The recipient can be for example the customer of the restaurant ordering the meal delivery from the restaurant. Recipients phone number is entered into the cellular phone 702.

Then a text message is sent from the cellular phone 702 to the recipient's phone 706. The software application enables the text message to include a selectable link and any optional message. In some embodiments this selectable link is a URL code that includes at the end of the URL the unlock code. By way of non-limiting example if the unlock code is “1234”, an exemplary URL code would be “http://f3.to/p.php?n=1234”. This URL is included in the text message automatically by software running on the cellular phone 702. On recipient's cellular phone 706, the text message including the unlock code and the clickable link is received. Once the locked container with the ordered food inside and the cellular phone 708 in the container holster has been delivered to the recipient, the recipient user can then attempt to open the container to access the food the recipient has ordered. In response to the recipient user of the cellular phone 706 activating the clickable link, the web browser opens a web browser. Software application running on server 801 reads the URL link, hashes it redirects the cellular phone 706 to a preexisting playable audible file associated with the unlock code.

The recipient should hold cellular phone 706 near the cellular phone 708. In some embodiments, the audible tones are played more than once to trigger the microphone of cellular phone 708 to listen for the codes. In some embodiments, cellular phone 708 is configured to be in a listening mode once the container has been locked. Once detected on cellular phone 708, the playing audible tones are converted by cellular phone 708 back into a code.

In some embodiments extended DTMF (dual tone multi frequency signaling) detection is used by the software application to detect and decode the audible tones back into a code. The software application to decode can be running on the cellular phone 708, the server 801 of both the cellular phone 708 and the server. If determined code matches previously selected unlock code, cellular phone sends unlock signal to electro-mechanical assembly and actuator opens the container lock. In some embodiments, the cellular phone 708 send signals to open the lock actuator using a variant of audio serial protocol.

The recipient is now able to now open the container and access the food that the recipient ordered. If code does not match previously selected unlock code, a brief error message is provided on the cellular phone 708. If code does not match, cellular phone 708 will display a brief error message. To close and lock the box, recipient or another user touches a button on the cellular phone. For multiple deliveries, code can/should be reused until reset back at the restaurant. This minimizes touching.

In some embodiments, use of audible tones can be omitted and only the code sent to the recipient's cellular phone 706 which the recipient can then use to manually enter into the cellular phone 708 to open the container lock.

It will be understood that the method of FIGS. 23A and 23B are not limited to the example in which a recipient is ordering food from a restaurant. The method can be implemented in any application in which secure transportation items is necessary. For example, in some embodiments, the method of operation of the system can be for use in delivering in the container private or sensitive documents. In some other embodiments, the method of operation of for use in securely transporting in the container money/currency. In yet some other embodiments, the method of operation of the system can be for delivering in the container medical supplies.

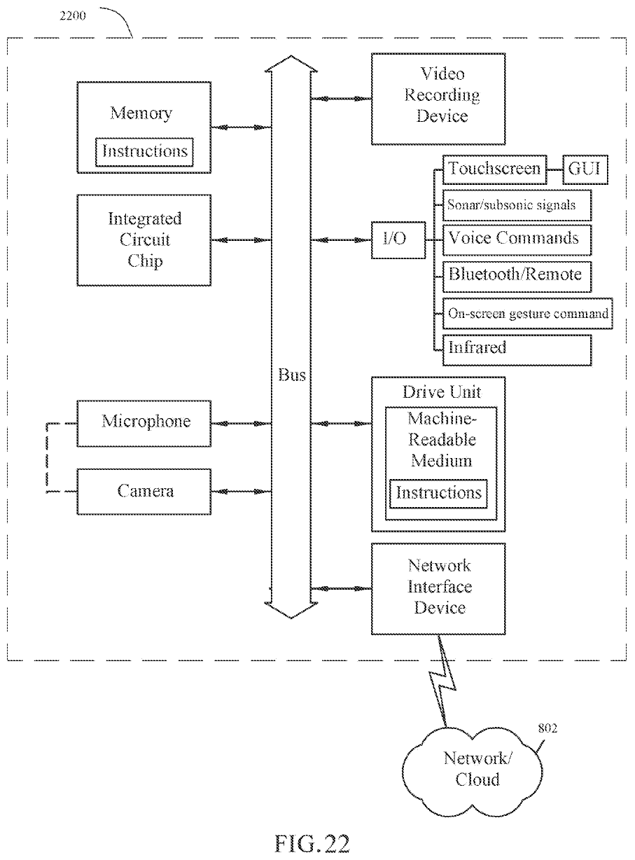

FIG. 22 is a diagrammatic representation of an exemplary electronic device 2200 which may be incorporated within one or more of the electronic devices (for example code receiving unit 8, which may be for example cellular phone 708, cellular phone 702, server 801, network 802, etc.) within which a set of instructions for causing the electronic device to perform any one or more of the methodologies discussed herein may be executed.

In various example embodiments, the electronic device operates as a standalone device or may be connected (e.g., networked) to other devices. In a networked deployment, the electronic device may operate in the capacity of a server or a client machine in a server-client network environment, or as a peer machine in a peer-to-peer (or distributed) network environment. The electronic device may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that device. Further, while only a single electronic device is illustrated, the term “device” shall also be taken to include any collection of devices that individually or jointly execute a set (or multiple sets) of instructions to perform any one or more of the methodologies discussed herein.

The example electronic device 2200 includes an integrated microchip which may be a processor or multiple processors (e.g., CPU, GPU, or both), and a main memory and/or static memory, which communicate with each other via a bus. In other embodiments, the electronic device 2200 may further include a video display (e.g., a liquid crystal display (LCD)). The electronic device 2200 may also include an alpha-numeric input device(s) (e.g., a keyboard), a cursor control device (e.g., a mouse), a voice recognition or biometric verification unit (not shown), a drive unit (also referred to as disk drive unit), a signal generation device (e.g., a speaker), a universal serial bus (USB) and/or other peripheral connection, and a network interface device. In other embodiments, the electronic device 2200 may further include a data encryption module (not shown) to encrypt data.

The processor of the chip can be a module operably associated with the drive unit, with the drive unit including a computer or machine-readable medium on which is stored one or more sets of instructions and data structures (e.g., instructions) embodying or utilizing any one or more of the methodologies or functions described herein. The instructions may also reside, completely or at least partially, within the memory and/or within the processors during execution thereof by the electronic device 2200. The memory and the processors may also constitute machine-readable media.

The instructions may further be transmitted or received over a network via the network interface device utilizing any one of a number of well-known transfer protocols (e.g., Extensible Markup Language (XML)). While the machine-readable medium is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the device and that causes the device to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals.

Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

It is appreciated that the software application is configured or configurable to be stored in any memory of the electronic device 2200 or on a remote computer in communication with the electronic device 2220. The software application is configured or configurable to include the interface capable of allowing the processes set forth in any of the embodiments described herein.

### OTHER ALTERNATIVES

The above advantages are exemplary, and these or other advantages may be achieved by the invention. Further, the skilled person will appreciate that not all advantages stated above are necessarily achieved by embodiments described herein.

In the foregoing specification, the invention has been described with reference to specific examples of embodiments of the invention. It will be evident, however, that various modifications and changes may be made therein without departing from the broader spirit and scope of the invention as set forth in the appended claims. The connections as discussed herein may be any type of connection suitable to transfer signals from or to the respective devices, for example via intermediate devices.

Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. In addition, plurality of connections may be replaced with a single connection that transfers multiple signals serially or in a time-multiplexed manner. Likewise, single connections carrying multiple signals may be separated out into various different connections carrying subsets of these signals. Therefore, many options exist for transferring signals.

Those skilled in the art will recognize that the boundaries between logic blocks are merely illustrative and that alternative embodiments may merge logic blocks or circuit elements or impose an alternate decomposition of functionality upon various logic blocks or circuit elements.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations are merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner. For example, processing in relation to different groups of profiles may be allocated to respective different integrated circuits.

Also for example, the examples, or portions thereof, may be implemented as soft code representations of physical circuitry or of logical representations convertible into physical circuitry, such as in a hardware description language of any appropriate type,

Also, the invention is not limited to physical devices or units implemented in nonprogrammable hardware but can also be applied in programmable devices or units able to perform the desired device functions by operating in accordance with suitable program code, for example a Field Programmable Gate Array (FPGA).

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as “one, or more than one.” Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are arbitrarily used to distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

As used throughout this application, the word “may” is used in a permissive sense (i.e., meaning having the potential to), rather than the mandatory sense (i.e., meaning must). Similarly, the words “include,” “including,” and “includes” mean “including, but not limited to” the listed item(s).

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112, paragraph six, interpretation for that unit/circuit/component.

Unless specifically stated otherwise as apparent from the foregoing discussions, it is appreciated that throughout the present description of embodiments, discussions utilizing terms such a “sending” or “receiving” refer to the actions and processes of an integrated circuit, an ASIC, a memory device, a computer system, or similar electronic computing device. The memory device or similar electronic computing device manipulates and transforms data represented as physical (electronic) quantities within the devices' registers and memories into other data similarly represented as physical quantities within the devices' memories or registers or other such information storage, transmission, or display devices.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures and one or more may be omitted, as appropriate. For example, two blocks shown in succession may, in fact, be executed substantially concurrently, or the blocks may sometimes be executed in the reverse order, depending upon the functionality involved. It will also be noted that in some embodiments, one or more blocks may be omitted, where appropriate. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that the described embodiments of the invention are illustrative only and that modifications thereof may occur to those skilled in the art. Accordingly, this invention is not to be regarded as limited to the embodiments disclosed, but is to be limited only as defined by the appended claims herein. It will further be understood that any features described in relation to any particular embodiment may be featured in combinations with other embodiments, for avoidance of doubt. While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A programmable lock food and drinks delivery container comprising:
an insulated food grade container;
a lock assembly;
a number code receiver assembly enclosed within a number code receiver assembly housing;
a number code receiver assembly housing retaining member;
an electronic numerical code generating system;
wherein a phone electronic system transmits a numerical code generated by the electronic numerical code generating system to a smart phone of a recipient of the insulated food grade container;
the lock assembly including an electro-mechanical sliding u-shaped finger locking member finger that extends through an aperture in the insulated food grade container;
the number code receiver assembly housing retaining member fixedly attached to an outside wall of the insulated food grade container;
the u-shaped finger locking member also capable of penetrating an aperture in a metal flange attached to the number code receiver assembly housing retainer and also penetrating an aperture in a zipper pull tab;
the number code receiver assembly including a keypad, a numeric display, a programmable microprocessor, a rechargeable battery, and a short-range wireless receiver contained within a hollow housing; and
the recipient of the insulated food grade container capable of sliding the u-shaped finger locking member away from the aperture of the zipper pull tab by pressing code numbers received from the electronic numerical code generating system thereby allowing the recipient to unzip the insulated food grade container and have access to the contents of the insulated food grade container.

2. A programmable lock food and drink delivery container as claimed in claim 1 wherein the number code receiver housing is removable and can be placed in a charging station and recharged via a recharging cable; and
the recharging cable is also capable of conducting a unique number code to the number code receiving assembly.

3. A programmable lock food and drink delivery container as claimed in claim 1 wherein the numerical code can also be transmitted by the recipient pressing an audio tone message on his or her phone; and
the audio tones being received by a microphone within the number code receiver assembly and causing the u-shaped finger locking member to slide away from the zipper tab without the need to touch the code numbers on the keypad.

4. A programmable lock food and drink delivery container as claimed in claim 1 wherein the container is constructed as a box.

5. A programmable lock food and drink delivery container as claimed in claim 1 wherein the container is constructed as a bag, wherein the bag may be collapsible.

6. A programmable lock food and drink delivery container as claimed in claim 1 wherein the container comprises multiple compartments, wherein the compartments may be of variable sizes capable of accepting variety of food items, wherein furthermore the compartments may be cup holders.

7. A programmable lock food and drink delivery container as claimed in claim 1 wherein the container may be constructed in a variety of sizes.

8. A method of securely delivering items to a recipient, wherein the method comprises:
on a code receiving unit attached or attachable to a container, selecting an unlock code;
using an electro-mechanical assembly, locking the container in response to the electro-mechanical assembly receiving the code;
entering or selecting the same unlock code on a cellular phone, sending the unlock code together with a selectable link to recipient's cellular phone;
receiving on the recipient's cellular phone the unlock code together with the selectable link;
in response to activating the selectable link on the recipient's cellular phone, redirecting the recipient's cellular phone to a preexisting playable audible file associated with the unlock code;
playing audible tones by the recipient cellular phone, playing said audible file near the code receiving unit of the container;
detecting the audible tones using the code receiving unit;
converting the audible tones into a code;
determining if the code provided from converting the audible tone is the same as the previously selected unlock code;
in response to determining the code provided from converting the audible tone is the same as the previously selected unlock code sending from the code receiving unit an unlock signal to the electro-mechanical assembly to unlock the container; and
using the electro-mechanical assembly, unlocking the container in response to the electro-mechanical assembly receiving the unlock signal.

9. The method of claim 8, wherein the code receiving unit is a cellular phone.

10. A method of securely delivering food and drinks to a user, wherein the method comprises:
a user orders food and drinks from a restaurant using a cell phone app;
a delivery person takes a programmable lock food and drinks delivery container to the restaurant;
a restaurant employee opens the programmable lock food and drink delivery container using the cell phone app;
the restaurant employee puts the food and drinks into the programmable lock food and drink delivery container and locks the container using the cell phone app;
the restaurant employee sends a text message containing a code necessary to open the programmable lock food delivery container to the user, wherein the text message may be sent by one or more electronic message delivery system;
the user unlocks the delivered programmable lock food and drinks delivery container using the code contained in the text message sent by the restaurant employee; and
the programmable lock food and drinks delivery container gets unlocked ready for the user to retrieve the contents of the programmable lock food and drinks delivery container.
